(19) United States
(12) Patent Application Publication
(10) Pub. No.: US 2005/0204009 A1
(43) Pub. Date: Sep. 15, 2005

(54) System, method and computer program product for prioritizing messages

(76) Inventors: Devapratim Hazarika, San Francisco, CA (US); Frank Kang, San Francisco, CA (US)

Correspondence Address: SQUIRE, SANDERS & DEMPSEY L.L.P, 600 HANSEN WAY, PALO ALTO, CA, 94304-1043, US

(21) Appl. No.: 11/075,194

(22) Filed: Mar. 7, 2005

Related U.S. Application Data
(60) Provisional application No. 60/551,451, filed on Mar. 9, 2004.

(51) Int. Cl. G06F 15/16

(52) U.S. Cl. 709/206

(57) ABSTRACT

A system, method and computer program product for prioritizing a message are described. In one embodiment, information about one or more characteristics of a message may be obtained. A score for the message may be calculated based on the obtained information. A priority based on the calculated score may then be assigned to the message.

### CROSS-REFERENCE TO RELATED APPLICATIONS

This application claims the benefit of U.S. Provisional Application No. 60/551,451, filed Mar. 9, 2004 which is incorporated by reference herein in its entirety.

### TECHNICAL FIELD

Embodiments of the present invention relate generally to information management and, more particularly, to organizing messages such as email messages.

### BACKGROUND

Electronic Mail (“email” or “e-mail”), essentially an electronic version of the postal service, is an application that is used to communicate electronic information between individuals. Each year, billions of messages are transported between friends, business acquaintances, junk e-mailers, members of mailing lists and so on.

As email replaces the phone and the postal service as a method of communication between people in the business environment, the problem of “email overload,” or the receipt of too many emails to effectively process in the time available to the recipient, becomes overwhelming. Many business users report receiving hundreds of emails a day, ranging from mission critical business messages to junk mail not worth the time to read. Automation is required to assist the user in sorting through high volumes of email; prioritizing those messages so that the user can easily identify and address email that is likely to be important to them.

### SUMMARY

A system, method and computer program product for prioritizing messages are described. In one embodiment, information about one or more characteristics of a message may be obtained. A score for the message may be calculated based on the obtained information. A priority based on the calculated score may then be assigned to the message.

The message may be presented according to the assigned priority and, in one embodiment, the message may be presented with a visual indicator indicative of the assigned priority.

In another embodiment, a notification may be generated if the assigned priority of the message meets a threshold condition.

The information about the characteristics of the message may be obtained after a messaging application receives the message.

The score may comprise a plurality of sub-scores associated with various characteristics of the message. The score for the message may also be modified by a scaling factor.

The obtained information may relate to associations between an address of the sender of the message and a recipient of the message. In one embodiment, the obtained information may include information about a domain associated with the sender. In another embodiment, the obtained information may include information about the frequency that the recipient responds to messages from the sender.

The obtained information may relate to a predefined priority associated with the message. In one embodiment, the predefined priority may be defined by a recipient.

The obtained information may relate to the participation of a recipient in a message thread associated with the message. In one embodiment, the obtained information may include information about whether the recipient is an initiator of the message thread. In another embodiment, the obtained information may include information about the number of previous messages sent by the recipient in the message thread.

The obtained information may relate to a measure of directness of the message to the recipient. In one embodiment, the obtained information may include information about whether the recipient is included in a “To” recipient address field of the message, a carbon copy (“CC”) recipient address field of the message, and/or a blind carbon copy (“BCC”) recipient address field of the message. In another embodiment, the obtained information may include information about whether the recipient is the only recipient included in the associated recipient address field.

### BRIEF DESCRIPTION OF THE DRAWINGS

FIG. 1 is a flowchart of an illustrative process for assigning a priority to an individual email message in accordance with an exemplary embodiment;

FIG. 2 is a flowchart of an illustrative process for computing known address sub-score for a composite email message prioritization score in accordance with an exemplary implementation;

FIG. 3 is a flowchart of an illustrative process for computing a message and thread priority sub-score for a composite email message prioritization score in accordance with an exemplary implementation;

FIG. 4 is a flowchart of an illustrative process for computing a thread participation sub-score for a composite email message prioritization score in accordance with an exemplary implementation;

FIG. 5 is a flowchart of an illustrative process for computing a message directness sub-score for a composite email message prioritization score in accordance with an exemplary implementation;

FIG. 6 is a flowchart of an illustrative process for performing a “To:” recipient address field weighting process in accordance with an exemplary implementation;

FIG. 7 is a flowchart of an illustrative process for performing a “CC:” recipient address field weighting process in accordance with an exemplary implementation;

FIG. 8 is a flowchart of an illustrative process for computing a composite priority score for an email message in accordance with an exemplary implementation;

FIG. 9 is a schematic block diagram of an exemplary environment for implementing a message prioritizing system;

FIG. 10 is a flowchart of an exemplary process for prioritizing a message;

FIG. 11 is a schematic diagram of an illustrative network system in accordance with one embodiment; and

FIG. 12 is a schematic diagram of a representative hardware environment in accordance with one embodiment.

### DETAILED DESCRIPTION

Embodiments and implementations described herein generally relate to an electronic mail message prioritizing system for determining an email message's priority based on various weighted characteristics of the message. To help resolve the email overload problem, embodiments may be implemented to assess a priority score to a user's individual email messages that takes into account multiple attributes of the message such as, for example, the sender of the message, the directness of the message to the user, participation by the user in the email conversation, and so on.

Embodiments of the email prioritizing system may analyze given characteristics of an individual email message (including addressees, subject name, author, and manually set message & thread priority) and assesses a composite priority score for each individual email based one or more (or all) of the following factors: known addresses; message and thread priorities; thread participation; and message directness. Embodiments of the email prioritizing system may also use scaling factors to help provide a user the ability to adjust how much weight may be given to each of the four factors. For example, a user may decide that thread participation is more important than message directness and weight the factor scores accordingly. A composite score, comprising a sum of the various factor scores may then be assigned to an individual message. The composite scores of the various email in the Inbox of a user's email application then be used to identify the likely priority the email will have to the user.

With respect to the known addresses factor, embodiments of the email prioritizing system may identify the author of the email and then perform an analysis to assess a known addresses score (or sub-score) for the email based on: a pre-determined priority for the author of the email (that may be set by the user or a system administrator); a domain address of the author of the email (e.g., “clearcontext.com” is the domain of the email address “sender@clearcontext.com”); and/or the number of times the user has replied (e.g., reply emails) to the author.

With respect to the domain address of the author, the analysis may determine whether or not the domain has been previously identified as one that is (or may be) important to the user. In one implementation, if a contact for the author is found in a contact database of the user (e.g., an address book of a messaging application used by the user), the domain address factor may be ignored in the analysis.

Embodiments of the email prioritizing system may assess message and thread priority score (or sub-score) by determining whether a priority has been manually assigned by the user to the message thread of a given email (also known as a “conversation” e.g., a related group of emails defined as an initial email and the subsequent email replies). Additional consideration may also be given to an individual message priority set in the native email application. When determining the impact individual message priority set in the native email application will have, embodiments of the present invention may determine whether or not the priority was assigned by a trusted source.

Embodiments of the email prioritizing system may assess a thread participation score (or sub-score) based on the number of responses the user has made within a given email thread and whether or not the user is the originator of the thread. In one implementation, a limit may be set to ensure that email threads having a large number of responses from the user do not result in an artificially high thread participation score.

Embodiments of the email prioritizing system may asses a message directness score (or sub-score) for an email based on whether the author's name is included in the “To:” and/or “CC:” fields of the email message and/or whether or not the email message is addressed to the user alone or to several other recipients. In one implementation, a limit may be placed on the message directness score to help ensure that the priority of a given email message is not artificially inflated.

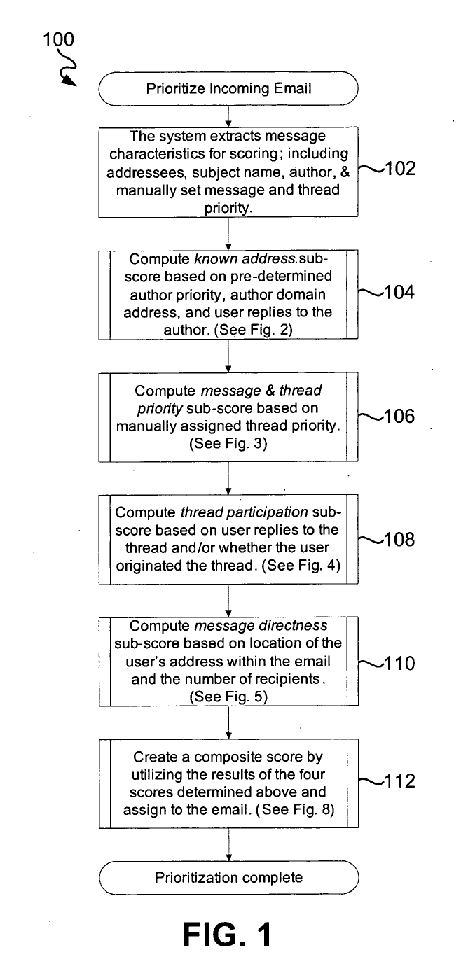

FIG. 1 is a flowchart of a process 100 for assigning a priority to an individual email message in accordance with an exemplary embodiment. Please note that the elements presented in a Courier font in FIGS. 1 through 8 may represent static variables defined by the user and/or system administrator prior to the execution of the various processes set forth herein. In operation 102, various characteristics of an incoming email message may be extracted for scoring including: addresses, subject name, author, and manually set message and thread priority.

In operations 104, 106, 108 and 110 various scores are computed for the email based on the characteristics extracted from the email. More specifically, a known address sub-score may be computed in operation 104 based on predetermined priority associated with the author of the message, user replies to the author and/or a network domain address associated with the author (i.e., the author's domain). In operation 106, a message and thread priority sub-score may be computed based on a manually assigned thread priority. A thread participation sub-score may also be computed in operation 108 based on user replies to the email thread and/or whether the user is the originator of the email thread. A message directness sub-score may be computed based on the location of the user's email address in the received email as well as the total number of recipients of the email in operation 110. Using the sub-scores computed in operations 104, 106, 108 and 110, a composite score for the email may be created and assigned to the email in operation 112. The email may then be prioritized using the composite score.

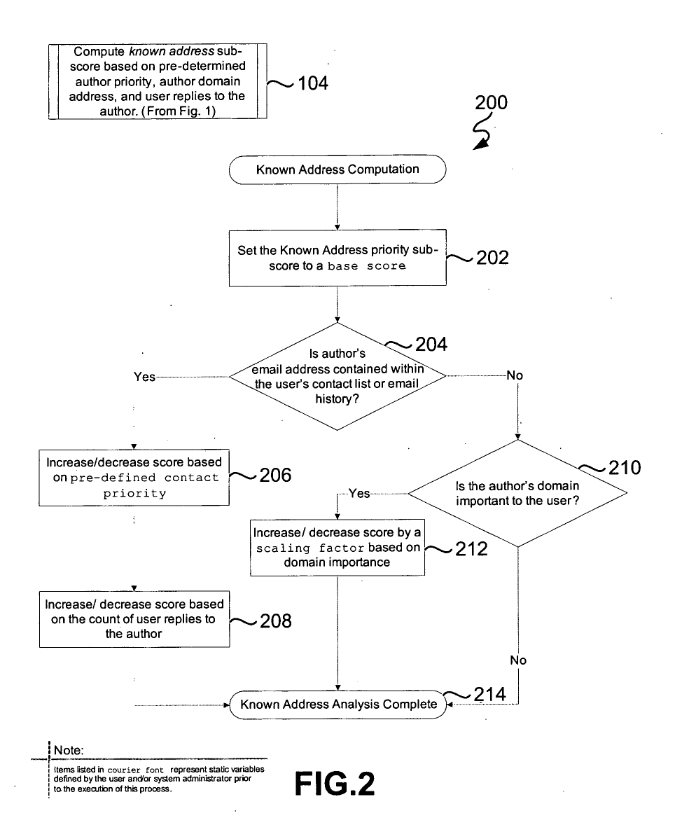

FIG. 2 is a flowchart of a process 200 for computing known address sub-score/component of an email message prioritization score/composite score in accordance with an exemplary implementation of operation 104 of the process 100 set forth in FIG. 1. In operation 202, the known address sub-score for the email may be set to an initial base score. In operation 204, the user's contact list/address book and/or previously received emails (i.e., the user's email history) may be examined to determine whether either of them contains the email address of the author of the received email.

If the author's email address is found in the user's contact list and/or email history, then the known address base score may be adjusted (i.e. increased or decreased) based on a predefined contact priority associated with the author and/or the number of email replies the user has made to the author in operations 206 and 208.

On the other hand, if the author's email address is not found in the user's contact list and/or email history, then in operation 210, the domain of the email address of the author (e.g., the “clearcontext.com” in the email address “sender@clearcontext.com”) may be examined to determine whether it may be a domain designated as important to the user and, if so, the known address base score may be adjusted by a scaling factor based on the importance of the domain.

The resulting output 214 of the process 200 shown in FIG. 2 is the final known address sub-score that may be used in the derivation of the prioritization composite score for the email.

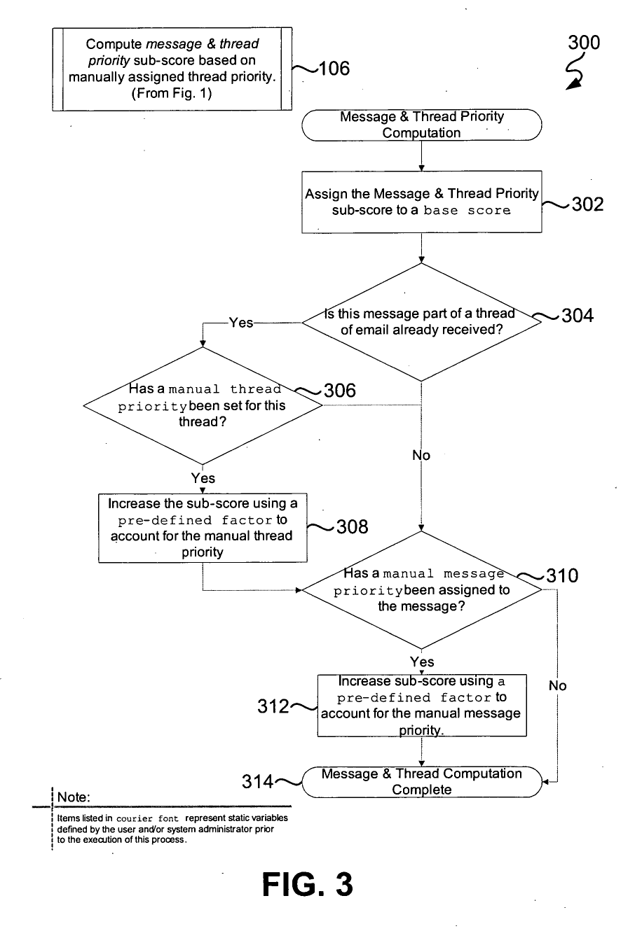

FIG. 3 is a flowchart of a process 300 for computing a message and thread priority sub-score/component of an email message prioritization score/composite score in accordance with an exemplary implementation of operation 106 of the process 100 set forth in FIG. 1. In operation 302, the message and thread priority sub-score for the received email may be set to an initial base score. If the email is determined to be part of an existing email message thread of the user and that the email message thread has been assigned a manual thread priority by the user (see operations 304 and 306), then the message and thread priority base score may be increased by a pre-defined thread priority factor corresponding to the assigned thread priority in operation 308.

In operation 310, the email message is examined to determine whether a message priority has been manually assigned to the email by a user. If the priority of the email message has been manually set by the user, the message and thread priority sub-score may be modified by a pre-defined email priority factor to account for the manually assigned message priority in operation 312. The resulting output 314 of the process 300 shown in FIG. 3 is the final message and thread priority sub-score that may be used in the derivation of the prioritization composite score for the email.

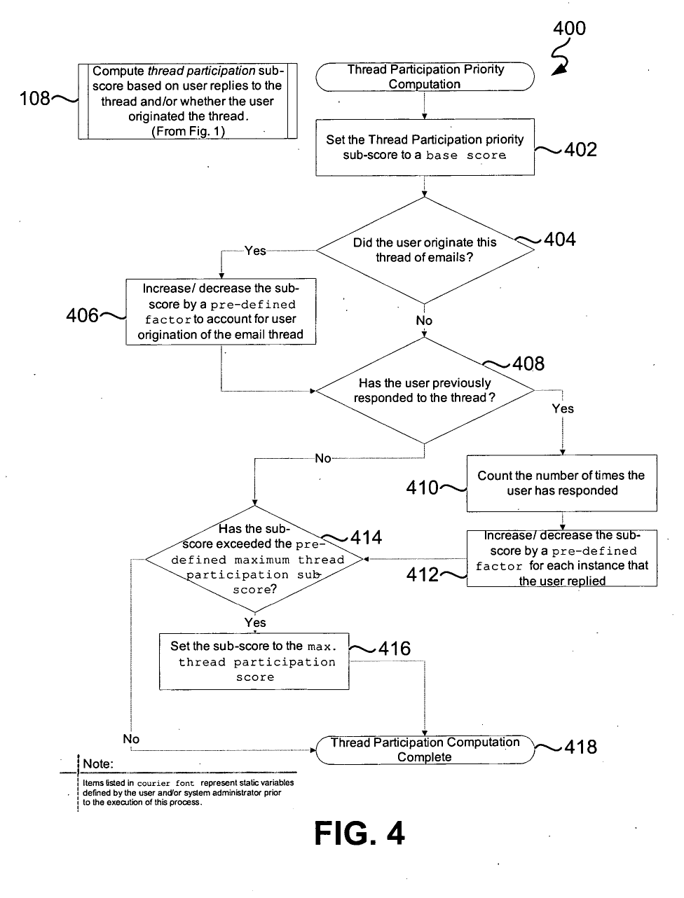

FIG. 4 is a flowchart of a process 400 for computing a thread participation sub-score/component of an email message prioritization score/composite score in accordance with an exemplary implementation of operation 108 of the process 100 set forth in FIG. 1. In operation 402, the thread participation sub-score for a received email message is initially set to a base score. If the user (i.e., the receiver of the incoming message) is determined to be the originator of the initial email of the email thread to which the incoming email belongs, then the thread participation sub-score may be adjusted by a pre-defined originator factor in operation 406 to account for the user being the originator of the incoming email's message thread.

The email may be further analyzed to determine whether the user has previously responded to another email in the message thread and if so, the number of times that the user has responded in the message thread in operations 408 and 410. The thread participation sub-score may then be adjusted in operation 412 by a pre-defined previous response factor in operation 412 for each instance that the user replied in the message thread.

In operation 414, a determination may be made to determine whether the thread participation sub-score exceeds a predefined threshold maximum score and if so, the thread participation sub-score is adjusted down to the maximum score in operation 416. The resulting output 418 of the process 400 shown in FIG. 4 is the final thread participation priority sub-score that may be used in the derivation of the prioritization composite score for the email.

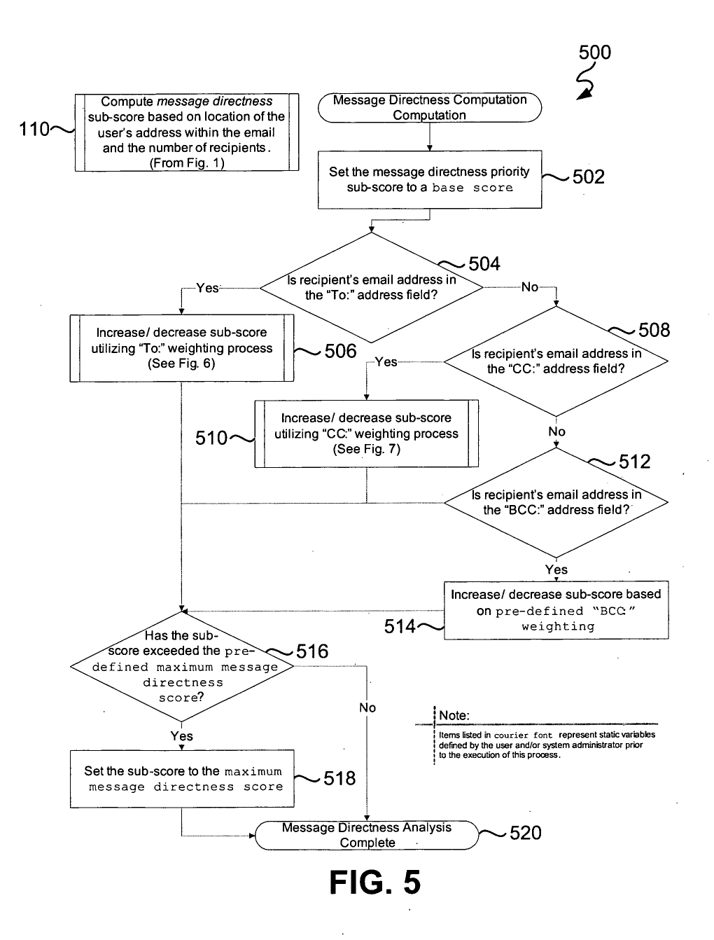

FIG. 5 is a flowchart of a-process 500 for computing a message directness sub-score/component of an email message prioritization score/composite score in accordance with an exemplary implementation of operation 110 of the process 100 set forth in FIG. 1. In operation 502, the message directness priority sub-score of an incoming email is initially set to a base score. If the user's (i.e., the recipient's) email address is included in the “To:” recipient address field of the email message, then the message directness sub-score for the email may be adjusted according to a “To:” weighting process (see operations 504 and 506). If the user's (i.e., the recipient's) email address is included in the “CC:” recipient address field of the email message, then the message directness sub-score for the email may be adjusted according to a “CC:” weighting process (see operations 508 and 510). If the user's (i.e., the recipient's) email address is included in the “BCC:” recipient address field of the email message, then the message directness sub-score for the email may be adjusted according to a predefined “BCC:” weighting factor (see operations 512 and 514).

In operation 516, the message directness sub-score of the email may be checked to see if it exceeds a predefined maximum message directness score and if so, the message directness sub-score is adjusted down to a value equal to the predefined maximum message directness score in operation 518. In one implementation, the predefined maximum message directness score may be equal in value to the predefined maximum thread participation score utilized in operation 414 of FIG. 4. The resulting output 520 of the process 500 shown in FIG. 5 is the final message directness sub-score that may be used in the derivation of the prioritization composite score for the email.

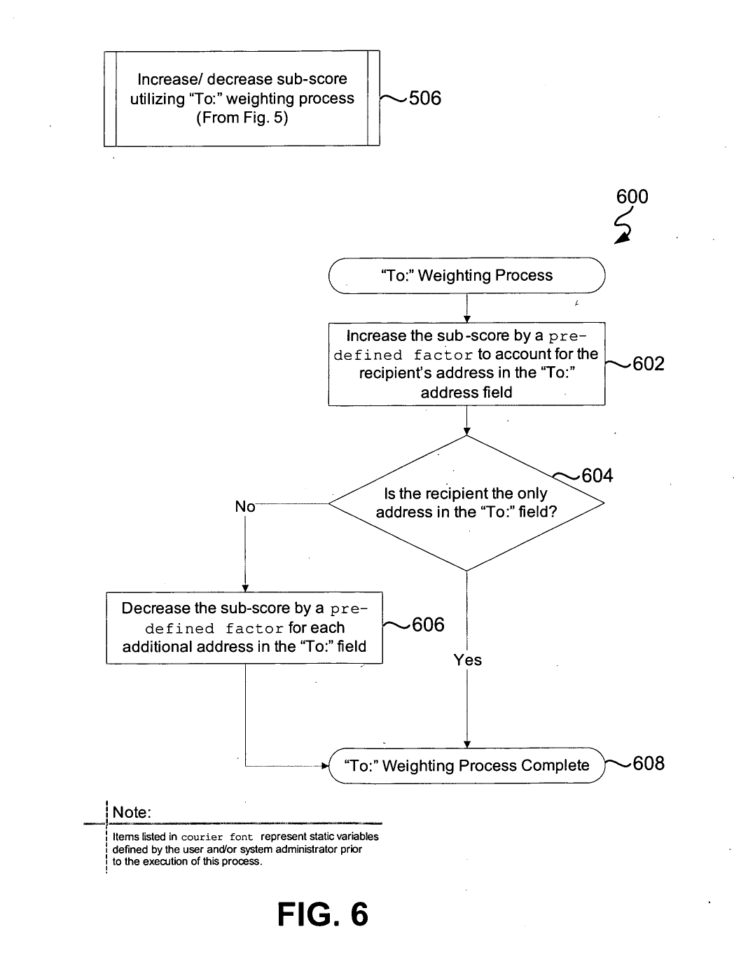

FIG. 6 is a flowchart of a process 600 for performing a “To:” weighting process in accordance with an exemplary implementation of operation 506 of the process 500 set forth in FIG. 5. In this process 600, the message directness sub-score may be weighted by taking into account whether or not the email message is addressed directly to the user (i.e., the recipient). In operation 602, the message directness sub-score may be adjusted (e.g., increased) by a predetermined “To:” field weighting factor to reflect that the user's email address is included in the “To:” recipient address field of the received email. If other recipients are included in the “To:” recipient address field of the email (i.e., the user's email address is not the only “To:” recipient of the email), then the message directness sub-score may be adjusted (e.g., decreased) by a predefined “To:” field weighting penalty (see operations 604 and 606). In one implementation, a separate predefined “To:” field weighting penalty may be applied for each additional recipient address included in the “To:” recipient address field of the received email. The output 608 of the process 600 may then be returned to the process 500 shown in FIG. 5 as an output of operation 506.

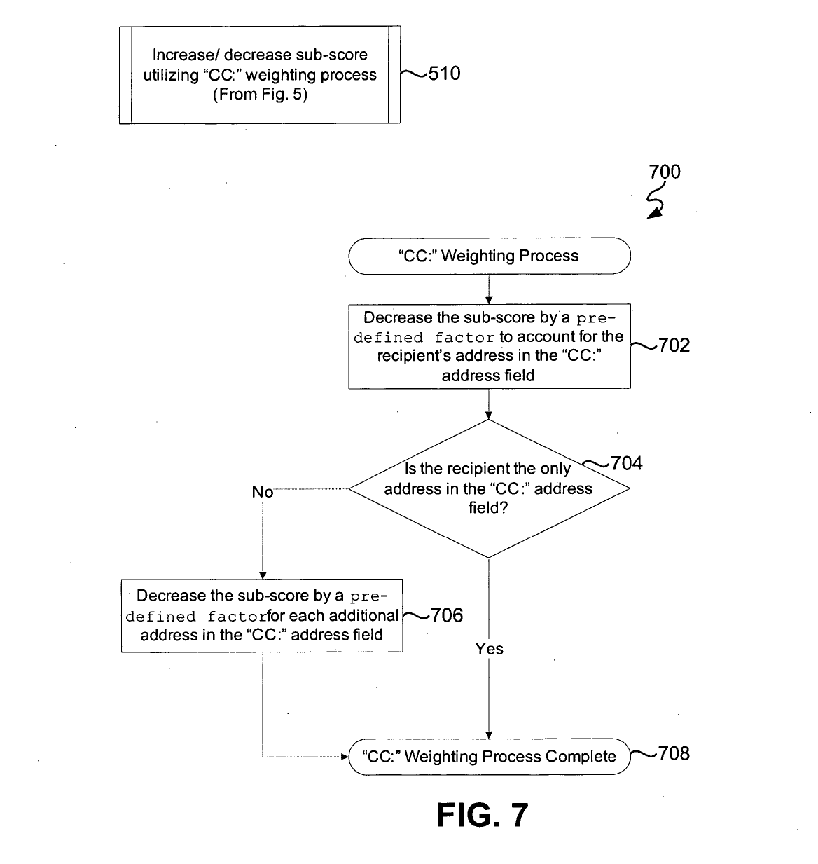

FIG. 7 is a flowchart of a process 700 for performing a “CC:” weighting process in accordance with an exemplary implementation of operation 510 of the process 500 set forth in FIG. 5. In this process 700, the message directness sub-score may be weighted to take into account that the user is a carbon copy (CC) recipient of the email message. In operation 702, the message directness sub-score may be adjusted (e.g., decreased) by a predetermined “CC:” field weighting factor to reflect the inclusion of the user's email address in the “CC:” recipient address field of the received email. If other recipients are also included in the “CC:” recipient address field of the email (i.e., the user's email address is not the only “CC:” recipient of the email), then the message directness sub-score may be adjusted (e.g., decreased) by a predefined “CC:” field weighting penalty (see operations 704 and 706). In one implementation, a separate predefined “CC:” field weighting penalty may be applied for each additional recipient address included in the “CC:” recipient address field of the received email. The output 708 of the process 700 may then be returned to the process 500 shown in FIG. 5 as an output of operation 510.

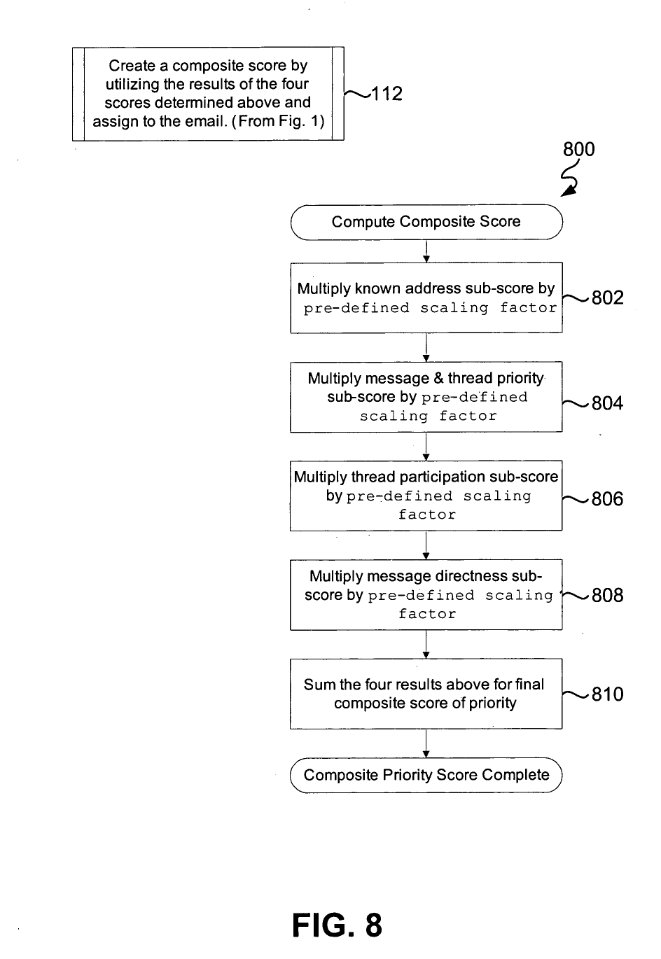

FIG. 8 is a flowchart of a process 800 for computing a composite score/priority score of an email message in accordance with an exemplary implementation of operation 112 of the process 100 set forth in FIG. 1. In operation 802, a scaling factor may be applied to the known address sub-score (see operation 104). In operation 804, a scaling factor may be applied to the message and thread priority address sub-score (see operation 106). In operation 806, a scaling factor may be applied to the thread participation sub-score (see operation 108). In operation 808, a scaling factor may be applied to the message directness sub-score (see operation 110). In operation 810, the scaled sub-scores may be combined together (e.g., added together) to result in a composite score of priority (or “priority composite score” or “priority score”) for the email message. The composite score output from operation 810 may then be utilized in assessing the priority of the given email message to the user. In one embodiment, the scaling factors utilized in operations 802, 804, 806 and 808 may be the same scaling factor or may be equal in value. In another embodiment, the scaling factors utilized in operations 802, 804, 806 and 808 each may be of a different value to adjust the weight of any of sub-scores on the composite score calculated in operation 810.

One exemplary use of the email priority system may be to analyze incoming messages within an email application such as Microsoft Outlook. As an email is received, priority may then be determined using the various scoring factors. Incoming email may then be ordered by the priority assigned with, for example, the most important email positioned at the top of the user's Inbox and the least important messages positioned towards the bottom of the Inbox. In one implementation, the visual appearance of an email in the Inbox may be changed to reflect the respective priority of the email. For example, higher priority email message may be displayed in a red color, lower priority emails may be displayed in a green color, and “junk” emails (i.e., the lowest priority emails) displayed in a grey color.

In another embodiment, the email priority scores may also be used in a notification system that may alert a user via a pop-up window, pager, or some other device when a single or pre-determined threshold of messages of a given priority is received by the email application of the user (e.g., when the user's Inbox receives a threshold number of email messages of a given priority).

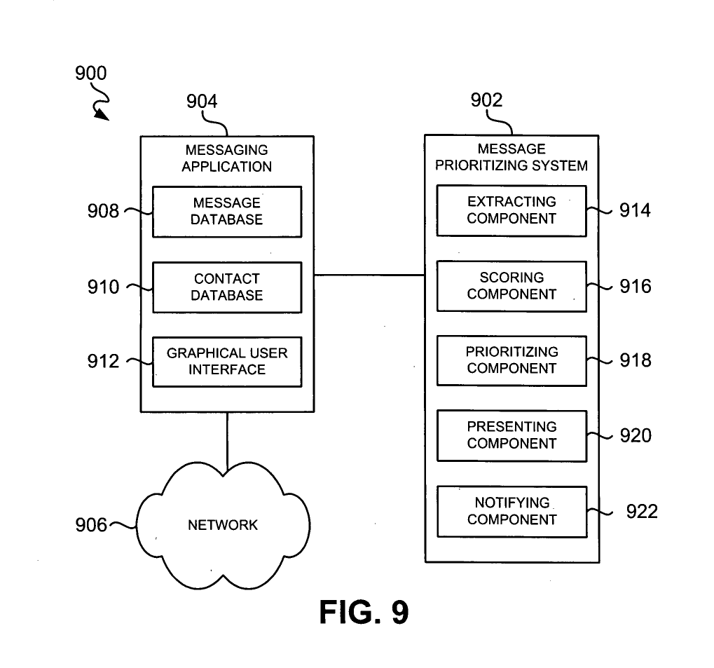

In accordance with various embodiments described herein, FIG. 9 is a schematic block diagram of an exemplary environment 900 for implementing a message prioritizing system 902. The message prioritizing system may be coupled to a messaging application 904 that may be capable of sending and receiving messages—via a network 906 for example. The messaging application 904 may include a message database 908 for storing (and retrieving) sent and received messages and a contact database 910 (e.g., a contact list and/or address book) for storing (and retrieving) contact information including address information associated with a given contact such as, for example, an email address of the contact. The messaging application may also include a graphical user interface 912 for presenting messages, contact information, and other information to a user (including, for example, additional information relating to the messages and/or the contacts) and for receiving commands and other information from the user.

The message prioritizing system 902 may comprise for example, a stand alone application or a plug-in application for the messaging application 904. The message prioritizing system is coupled to the messaging application 904 (or to various components thereof) to allow the messaging priority system 904 (and components 908, 910, 912 thereof) to access the messaging application 904 and its components. In one implementation, the messaging prioritizing system 902 may also be coupled to the network 906 either directly or through the messaging application 904 to permit communication with the messaging priority system over the network 906. The message prioritizing system 902 may include an extracting component 914 capable of obtaining information about one or more characteristics of a message, a scoring component 916 capable of calculating a score for the message based on the obtained information, and a prioritizing component 918 capable of assigning a priority to the message based on the calculated score.

In one embodiment, the messaging application 902 may also include a presenting component 920 capable of presenting the message according to its assigned priority and may further include a notifying component 922 for generating a notification if the assigned priority of the message meets a threshold condition.

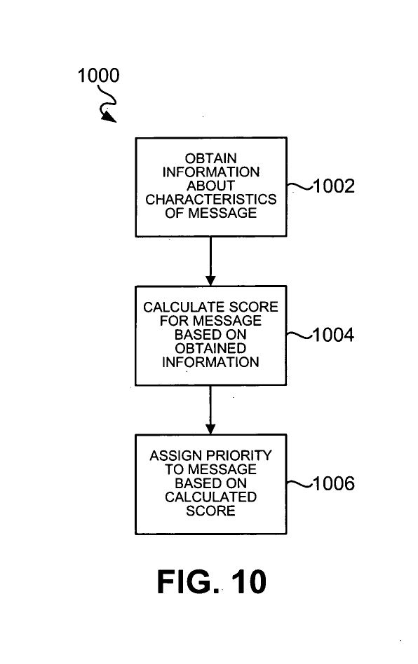

FIG. 10 is a flowchart of an exemplary process 1000 for prioritizing a message that may be performed, for example, utilizing the exemplary prioritizing system 902 of FIG. 9. In operation 1002, information about one or more characteristics of a message may be obtained. In operation 1004, a score for the message may be calculated based on the obtained information. In operation 1006, a priority based on the calculated score may be assigned to the message.

The message may then be presented according to the assigned priority and, in one embodiment, the message may be presented with a visual indicator indicative of the assigned priority. The visual indicator may comprise, for example, a color that is indicative/associated with the assigned priority. In one implementation, the message may be presented (e.g., displayed) to a recipient according to its assigned priority along with its associated visual indicator via a graphical user interface of a messaging application.

In another embodiment, a notification may be generated if the assigned priority of the message meets one or more threshold conditions. For example, the notification may be generated if a threshold number of messages of a given priority are received by a recipient's messaging application. The notification may be presented to the recipient utilizing a graphical user interface of a messaging application. For example, the notification may be presented in a popup window that is presented to the recipient. In another embodiment, the notification may be presented to a user via a communication device such as, for example, a text messaging feature of a cell phone or pager.

With regard to operation 1002, in one implementation, the message may comprise an email message and may be received via a network such as for example, an intranet (e.g., a local area network (LAN)) and/or a wide area network (WAN) such as the Internet. Information about characteristics of the message may be obtained after a messaging application receives the message. In one embodiment, the characteristics of the message may be obtained from an analysis of the message itself, (e.g., extracted directly from the message).

The obtained information may relate to associations between an address of the sender/author of the message and a recipient of the message. For example, information may be obtained about whether the address of the sender is included in a contact list or address book in a messaging application associated with the recipient and thus, a known associate of the recipient. In one implementation, the address of the sender may comprise a network address associated with the sender such as, for example, an email address of the sender. In one embodiment, the obtained information may include information about a domain associated with the sender obtained, for example, directly from the message itself (e.g., a domain name/host name of the sender's email address). In another embodiment, the obtained information may include information about the frequency that the recipient responds to messages from the sender. In one implementation, the frequency information may be obtained from an analysis of messages contained in a message database of a messaging application.

The obtained information may relate to a predefined priority associated with the message and/or message thread of a given message. In one embodiment, the predefined priority may be defined by a recipient.

The obtained information may relate to the participation of a recipient in a message thread associated with the message. In one embodiment, the obtained information may include information about whether the recipient is an initiator of the message thread (i.e., the author/sender of the original message that started the message thread). In another embodiment, the obtained information may include information about the number of previous messages sent by the recipient in the message thread (e.g., the number of replies or responses made by-the recipient in the message thread).

The obtained information may relate to a measure or degree of directness of the message to the recipient. In one embodiment, the obtained information may include information about whether the recipient (e.g., the email address of the recipient) is included in a “To” recipient address field of the message, a carbon copy (“CC”) recipient address field of the message, and/or a blind carbon copy (“BCC”) recipient address field of the message. In another embodiment, the obtained information may include information about whether the recipient is the only recipient included in a given recipient address field level and if not, how many additional other recipients (e.g., the email addresses of the other recipients) are included at the given recipient address field level.

With regard to operation 1004, the score for the message may be modified by one or more scaling factors that may be defined, for example, by the recipient of the message and/or based on one of the characteristics of the message. In one implementation, the recipient may be permitted to manually set one or more scaling factors via a graphical user interface of a messaging application. The score may even comprise a plurality of sub-scores associated with various characteristics of the message. In such an embodiment, one or more of the sub-scores may be modified by an associated scaling factor.

With regard to operation 1006, the system may include a plurality of differing priorities (or priority levels) each having an associated range of scores so that the priority assigned to a given message depends on where in the various scores ranges does the message's score lie (i.e., in which priority's range does the message's score fall). The ranges of the various priority levels may be determined based on a simple division of a wide range of scores or based on a statistical analysis of a set of sample scores. In one implementation, the priority of the message may increase as its score increases so that the higher the score, the higher the priority assigned to a given message.

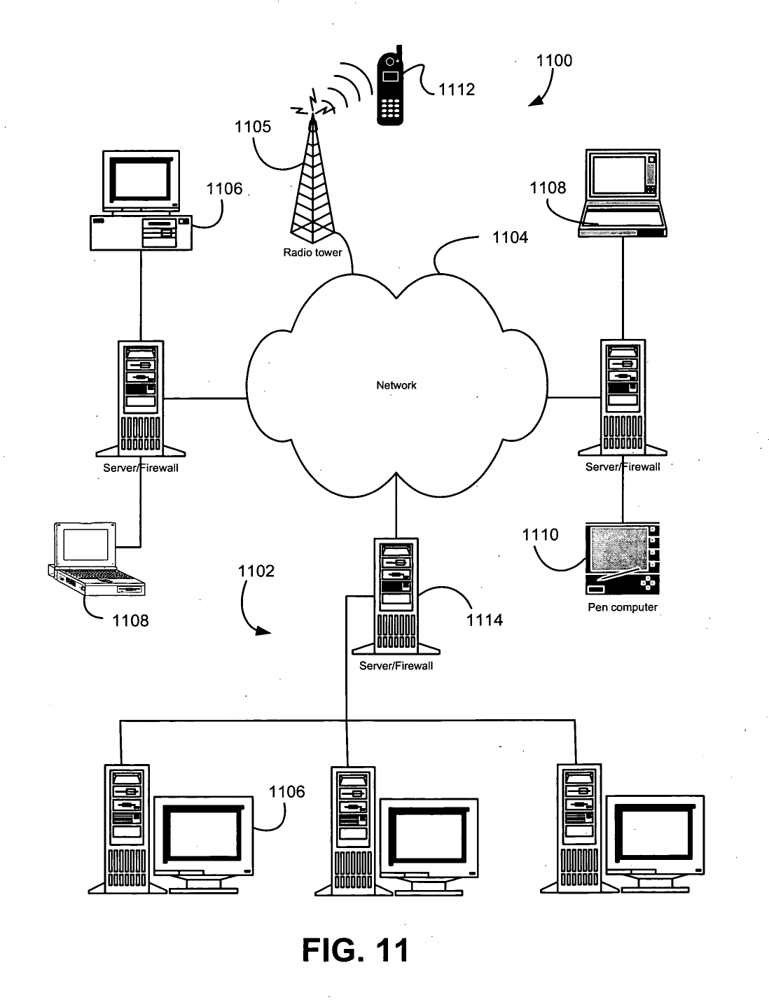

FIG. 11 illustrates an exemplary network system 1100 with a plurality of components 1102 in accordance with one embodiment of the invention. As shown, such components include a network 1104 which take any form including, but not limited to a local area network, a wide area network such as the Internet, and a wireless network 1105. Coupled to the network 1104 is a plurality of computers which may take the form of desktop computers 1106, lap-top computers 1108, hand-held computers 1110 (including wireless devices 1112 such as wireless PDA's or mobile phones), or any other type of computing hardware/software. As an option, the various computers may be connected to the network 1104 by way of a server 1114 which may be equipped with a firewall for security purposes. It should be noted that any other type of hardware or software may be included in the system and be considered a component thereof.

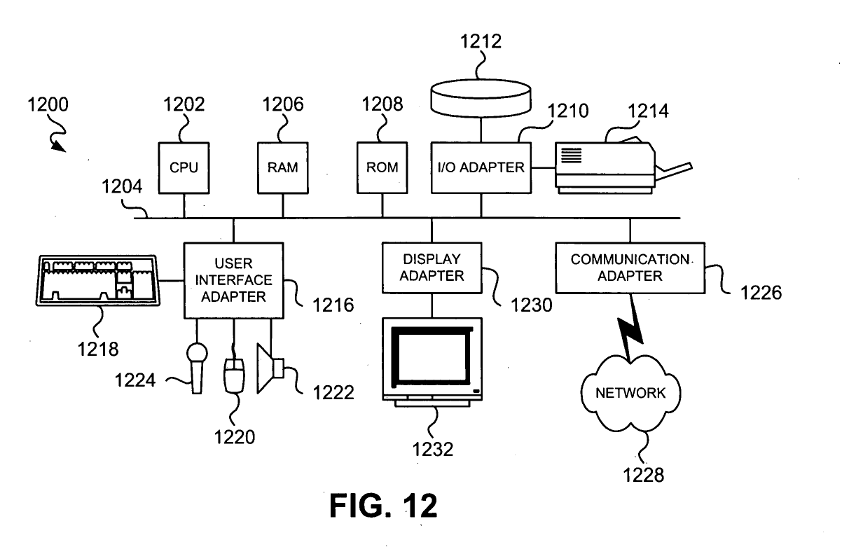

A representative hardware environment associated with the various components of FIG. 11 is depicted in FIG. 12. In the present description, the various sub-components of each of the components may also be considered components of the system. For example, particular software modules executed on any component of the system may also be considered components of the system. In particular, FIG. 12 illustrates an exemplary hardware configuration of a workstation 1200 having a central processing unit 1202, such as a microprocessor, and a number of other units interconnected via a system bus 1204.

The workstation shown in FIG. 12 includes a Random Access Memory (RAM) 1206, Read Only Memory (ROM) 1208, an I/O adapter 1210 for connecting peripheral devices such as, for example, disk storage units 1212 and printers 1214 to the bus 1204, a user interface adapter 1216 for connecting various user interface devices such as, for example, a keyboard 1218, a mouse 1220, a speaker 1222, a microphone 1224, and/or other user interface devices such as a touch screen or a digital camera to the bus 1204, a communication adapter 1226 for connecting the workstation 1200 to a communication network 1228 (e.g., a data processing network) and a display adapter 1230 for connecting the bus 1204 to a display device 1232. The workstation may utilize an operating system such as the Microsoft Windows Operating System (OS), the IBM OS/2 operating system, the MAC OS, and LINUX or UNIX operating systems. Those skilled in the art will appreciate that the various embodiments of the invention may also be implemented on platforms and operating systems other than those mentioned. Embodiments of the invention may also be written using Java, C, and the C++ language and utilize object oriented programming methodology.

In accordance with at least one embodiment, an address book or contact list may comprise a database in which email addresses and/or other contact information (e.g., e.g., name, address, telephone and facsimile numbers, email and website addresses, personal data) about individuals and/or groups may be stored. An address book/contact list may also be integrated with other components of a messaging application to help facilitate quick addressing of messages to be sent to a recipient. An address book/contact list may also permit the assigning of nicknames to a contact or group of contacts to help facilitate quicker access to the contact(s).

Wireless refers to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing.

A pop-up is a graphical user interface (GUI) display area, usually a small window, that suddenly appears (“pops up”) in the foreground of the visual interface. Pop-ups can be initiated by a single or double mouse click or rollover (sometimes called a mouseover), and also possibly by voice command or can simply be timed to occur. A pop-up window is usually smaller than the background window or interface; otherwise, it is may be called a replacement interface. On the World Wide Web, JavaScript (and less commonly Java applets) may be used to create interactive effects including pop-up and full overlay windows. A menu or taskbar pulldown can be considered a form of pop-up. So can the little message box you get when you move your mouse over taskbars in many PC applications.

Plug-in applications are programs that can easily be installed and used as part of your Web browser. A plug-in application is recognized automatically by the browser and its function is integrated into the main HTML file that is being presented.

A browser is an application program that provides a way to look at and interact with all the information on the World Wide Web. The word “browser” seems to have originated prior to the Web as a generic term for user interfaces that let you browse (navigate through and read) text files online. A Web browser may be considered a client program that uses the Hypertext Transfer Protocol (HTTP) to make requests of Web servers throughout the Internet on behalf of the browser user. While some browsers also support e-mail (indirectly through e-mail Web sites) and the File Transfer Protocol (FTP), a Web browser may not be required for those Internet protocols and more specialized client programs are more popular.

Encryption is the conversion of data into a form, called a ciphertext, that cannot be easily understood by unauthorized people. Decryption is the process of converting encrypted data back into its original form, so it can be understood. Rivest-Shamir-Adleman (RSA) is an Internet encryption and authentication system that uses an algorithm developed in 1977 by Ron Rivest, Adi Shamir, and Leonard Adleman. The RSA algorithm is a commonly used encryption and authentication algorithm and is often included as part of a web browser. The RSA algorithm involves multiplying two large prime numbers (a prime number is a number divisible only by that number and 1) and through additional operations deriving a set of two numbers that constitutes the public key and another set that is the private key. Once the keys have been developed, the original prime numbers are no longer important and can be discarded. Both the public and the private keys are needed for encryption/decryption but only the owner of a private key ever needs to know it. Using the RSA system, the private key never needs to be sent across the Internet. The private key is used to decrypt text that has been encrypted with the public key. Thus, if a first party sends a message to a second party, the recipient second party may be able to find out the first party's public key (but not the first party's private key) from a central administrator and encrypt a reply message back to the first party using the first party's own public key. When the first party receives the reply message, the reply message may be decrypted by the first party with the first party's private key. In addition to encrypting messages (which ensures privacy), a first party may be able authenticate themselves to second party so that the second party can confirm the identity of the first party (and thus know that it is really the first party who sent the message) by using a private key to encrypt a digital certificate. When the second party receives the encrypted digital certificate, the second party may use the first party's public key to decrypt it.

Based on the foregoing specification, embodiments of the invention may be implemented using computer programming or engineering techniques including computer software, firmware, hardware or any combination or subset thereof. Any such resulting program—having computer-readable code—may be embodied or provided in one or more computer-readable media, thereby making a computer program product (i.e., an article of manufacture) implementation of one or more embodiments described herein. The computer readable media may be, for instance, a fixed drive (e.g., a hard drive), diskette, optical disk, magnetic tape, semiconductor memory such as for example, read-only memory (ROM), flash-type memory, etc., and/or any transmitting/receiving medium such as the Internet and/or other communication network or link. An article of manufacture containing the computer code may be made and/or used by executing the code directly from one medium, by copying the code from one medium to another medium, and/or by transmitting the code over a network. In addition, one of ordinary skill in the art of computer science may be able to combine the software created as described with appropriate general purpose or special purpose computer hardware to create a computer system or computer sub-system embodying embodiments or portions thereof described herein.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

1. A method for prioritizing a message, comprising:
obtaining information about one or more characteristics of a message;
calculating a score for the message based on the obtained information; and
assigning a priority to the message based on the calculated score.

2. The method of claim 1, wherein the message is presented according to the assigned priority.

3. The method of claim 1, wherein the message is presented with a visual indicator indicative of the assigned priority.

4. The method of claim 1, wherein a notification is generated if the assigned priority of the message meets a threshold condition.

5. The method of claim 1, wherein the information about the one or more characteristics of the message is obtained after a messaging application receives the message.

6. The method of claim 1, wherein the score for the message is modified by a scaling factor.

7. The method of claim 1, wherein the score comprises a plurality of sub-scores each associated with at least one characteristic of the message.

8. The method of claim 1, wherein the obtained information relates to one or more associations between an address of a sender of the message and a recipient of the message.

9. The method of claim 8, wherein the obtained information includes information about a domain associated with the sender.

10. The method of claim 8, wherein the obtained information includes information about a frequency that the recipient responds to messages from the sender.

11. The method of claim 1, wherein the obtained information relates to a predefined priority associated with the message.

12. The method of claim 11, wherein the predefined priority is defined by a recipient.

13. The method of claim 1, wherein the obtained information relates to participation of a recipient in a message thread associated with the message.

14. The method of claim 13, wherein the obtained information includes information about whether the recipient is an initiator of the message thread.

15. The method of claim 13, wherein the obtained information includes information about a number of previous messages sent by the recipient in the message thread.

16. The method of claim 1, wherein the obtained information relates to a measure of directness of the message to the recipient.

17. The method of claim 16, the obtained information includes information about whether the recipient is included in at least one of: a To recipient address field of the message; a carbon copy (CC) recipient address field of the message, and a blind carbon copy (BCC) recipient address field of the message.

18. The method of claim 17, wherein the obtained information includes information about whether the recipient is the only recipient included in the associated recipient address field.

19. A system for prioritizing a message, comprising:
logic for obtaining information about one or more characteristics of a message;
logic for calculating a score for the message based on at least a portion of the obtained information about the one or more characteristics of the message; and
logic for assigning a priority to the message based on the calculated score.

20. A computer program product for prioritizing a message, comprising:
computer code for obtaining information about one or more characteristics of a message;
computer code for calculating a score for the message based on at least a portion of the obtained information about the one or more characteristics of the message; and
computer code for assigning a priority to the message based on the calculated score.
